(19) United States
(12) Patent Application Publication
(10) Pub. No.: US 2007/0047539 A1
(43) Pub. Date: Mar. 1, 2007

(54) Methods, systems, and computer program products for preserving sequencing of signaling messages at a routing node

(75) Inventors: Devesh Agarwal, Raleigh, NC (US); Raghavendra G. Rao, Cary, NC (US)

Correspondence Address: JENKINS, WILSON, TAYLOR & HUNT, P. A., 3100 TOWER BLVD, SUITE 1200, DURHAM, NC, 27707, US

(73) Assignee: Tekelec

(21) Appl. No.: 11/218,290

(22) Filed: Sep. 1, 2005

(51) Int. Cl. H04L 12/50; H04Q 11/00

(52) U.S. Cl. 370/384

(57) ABSTRACT

Methods, systems, and computer program products for preserving sequencing of signaling messages at a routing node are disclosed. First and second signaling messages are received at a routing node of a communications network. The first signaling message is received prior to the second signaling message. Next, it is determined whether processing is required for the first signaling message. In response to determining that processing is required for the first signaling message, first and second sequence identifiers are assigned to the first and second signaling messages, respectively, the first and second sequence identifiers indicating a relative sequence four routing the first and second signaling messages. Next, the first and second signaling messages are routed to the communications network based on the relative sequence indicated by first and second sequence identifiers.

### TECHNICAL FIELD

The subject matter described herein relates to the distribution and processing of messages in a communications network. More particularly, the subject matter described herein relates to methods, systems, and computer program products for preserving sequencing of signaling messages at a routing node.

### BACKGROUND ART

Within a signaling system 7 (SS7) communication network, call setup and teardown information is conveyed using ISDN user part (ISUP) messages. Typically, all ISUP messages associated with the same call or “circuit” are routed along the same signaling path between the originating and terminating offices involved in the call. The routing of these ISUP messages is commonly performed by SS7 signal transfer point (STP) routing nodes that reside in the network. As signaling networks have evolved, STP nodes have increasingly been used to perform message processing functions in addition to basic message routing functionality. One example of such message processing is triggerless location portability processing, which may be performed on ISUP messages.

A location portability lookup, also referred to as a reverse number portability lookup is a lookup based on the calling party digits in a message. Such a lookup may be required when a ported subscriber is calling another subscriber and it is desirable to determine the calling party directory number from the location routing number stored in the calling party number field of the ISUP message.

ISUP messages may require sequenced processing at a routing node such as an STP node. Examples of ISUP messages that may require sequenced processing at a routing node include ISUP initial address message (IAM) messages. An IAM message can be utilized in a call setup operation. One example of processing that may be performed at an STP for an IAM message is a location portability lookup.

Sometimes all of the dialed digits needed to initiate the call setup sequence are not transmitted in the IAM message. For example, the ITU ISUP protocol employs a SAM message and a subsequent directory number message (SDM) to carry additional called party (CdPA) information in addition to that provided in an IAM message. A detailed description of the ITU ISUP protocol may be found in ITU publications Q.761 Signaling System No. 7-ISDN User Part Functional Description, December 1999 and Q.762 Signaling System No. 7-IDSN User Part General Functions Of Messages And Signals, December 1999, the disclosures of which are herein incorporated by reference in their entirety. Thus, the information provided via one (or more) ISUP messages (e.g., IAM, SAM, SDM messages) may be necessary in order to complete the call setup.

Further, an ISUP processing application may require that such multiple, related messages be collected and analyzed before stateful and/or sequenced processing can be successfully completed. For example, commonly assigned, co-pending U.S. Patent Publication No. US 2002/0054674 (hereinafter, the '674 Publication), the disclosure of which is incorporated herein by reference in its entirety, discloses methods and systems for providing triggerless intelligent network screening services based on sequenced processing of call setup messages. In one embodiment of the subject matter disclosed in the '674 Publication, a triggerless screening service routing node, such as an STP, screens call setup messages, such as ISUP messages, and provides intelligent network services. Examples of intelligent network services provided include calling party screening, called party screening, charged party screening, and redirecting party screening. Each of these applications may utilize dialed digits collected from call setup messages to make a screening decision. Such processing may be sequenced in that IAM and SAM messages must be received, processed, and transmitted in order.

In order to ensure sequenced processing, routing nodes have been implemented to require processing related call setup messages with the same processor or that call setup information from one processor be forwarded to another processor in order. In certain cases, SAM messages may not require the processing that is required by their related IAM messages. In general, such message processing scenarios involve applications or services that do not require or make use of the subsequent dialed digit information contained in a SAM message. Examples of such signaling message processing scenarios include processing related to certain pre-paid calling services and processing related to certain location portability services. More particularly, the relevant scenarios include those pre-paid, location portability applications and services that require only calling party number (CgPN) information associated with a call. In these cases, an IAM message contains the complete CgPN identifier, and internal communication and processing bandwidth in a routing node may be wasted as a result of requiring all associated SAM messages to be unnecessarily sent to an application service processor.

Another problem with requiring that messages that are part of the same transaction follow the same path in a routing node is that messages relating to the same transaction must be correlated. Such correlation requires that the distributing processor maintain state for each transaction. Requiring the distributing processor to maintain state unnecessarily consumes routing node processing resources.

Accordingly, there exists a need for improved methods and systems for preserving sequencing of ISUP IAM and SAM signaling messages at routing nodes.

### SUMMARY

According to one aspect, the subject matter described herein comprises methods, systems, and computer program products for sequencing call setup messages in a routing node that includes a triggerless call setup message processing application. One method includes receiving first and second signaling messages at a routing node of a communications network. The first signaling message is received prior to the second signaling message. Next, it is determined whether processing is required for the first signaling message. In response to determining that processing is required for the first signaling message, first and second sequence identifiers are assigned to the first and second signaling messages, respectively. The first and second sequence identifiers indicate a relative sequence for routing the first and second signaling messages. Next, the first and second signaling messages are communicated to the communications network according to the relative sequence specified by the first and second sequence identifiers.

The subject matter described herein for preserving sequencing of signaling messages may be implemented using a computer program product comprising computer executable instructions embodied in a computer readable medium. Exemplary computer readable media suitable for implementing the subject matter described herein include disk memory devices, programmable logic devices, application specific integrated circuits, and downloadable electrical signals. In addition, a computer readable medium that implements the subject matter described herein may be distributed across multiple physical devices and/or computing platforms.

### BRIEF DESCRIPTION OF THE DRAWINGS

Exemplary embodiments of the subject matter will now be explained with reference to the accompanying drawings, of which:

FIG. 1 is an exemplary internal architecture of a signal transfer point (STP) node for preserving sequencing of signaling messages according to one embodiment of the subject matter disclosed herein;

FIG. 2 is an exemplary internal architecture for the link interface module (LIM) shown in FIG. 1;

FIG. 3 is a flow chart illustrating exemplary steps that may be performed by an application screening and sequencing function and I/O buffer in preserving sequencing of ISDN user part (ISUP) initial address message (IAM) messages and ISUP subsequent address message (SAM) messages according to an embodiment of the subject matter disclosed herein;

FIG. 4 is a block diagram illustrating the structure of an SS7 ISUP message;

FIG. 5 is an example of the communication of an IAM message and a SAM message through the internal architecture of an exemplary STP node according to one embodiment of the subject matter disclosed herein; and

FIG. 6 is another example of the communication of an IAM message and a SAM message through the internal architecture of an exemplary STP node according to one embodiment of the subject matter disclosed herein.

### DETAILED DESCRIPTION

According to one embodiment, the subject matter described herein includes a communications network routing node, such as a signal transfer point (STP), configured to process, route, and preserve the sequencing of signaling messages such as ISDN user part (ISUP) initial address messages (IAMs) and ISUP subsequent address messages (SAMs). Further, according to one embodiment, the subject matter described herein can provide triggerless location portability (TLP) and triggerless pre-paid screening (TPS) processing of IAM messages and preserve sequencing of the IAM messages and SAM messages. The EAGLE® STP, the IP^{7®} Secure Gateway, and the TEKSERVER® platform (all available from Tekelec of Calabasas, Calif.) are suitable systems for processing and preserving sequencing of signaling messages according to the subject matter disclosed herein.

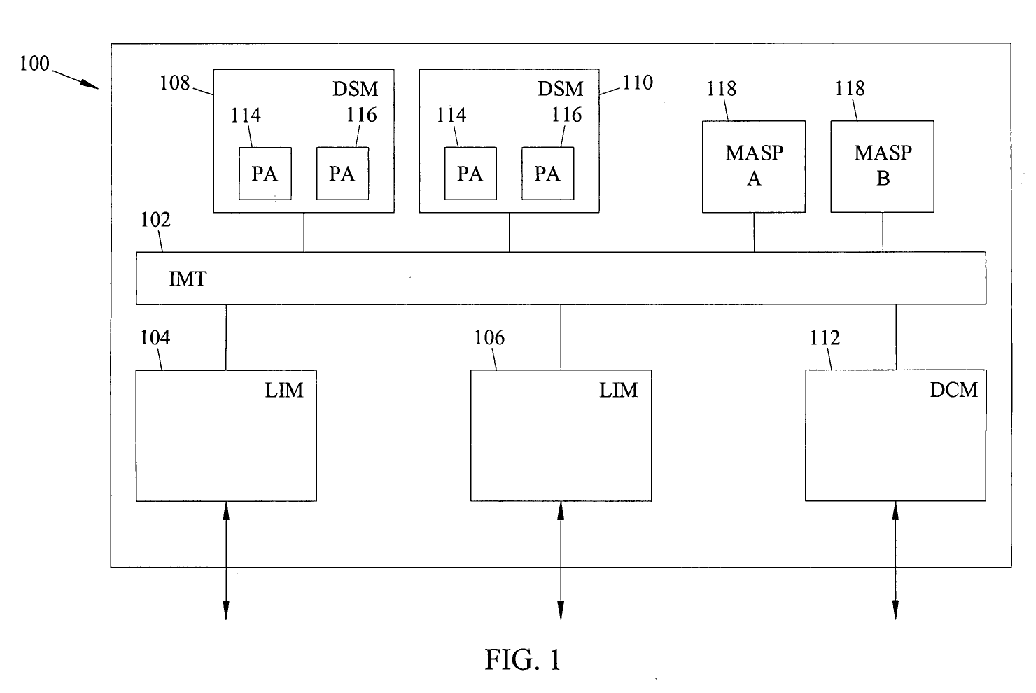

FIG. 1 illustrates an exemplary internal architecture of an STP node 100 for preserving sequencing of signaling messages according to one embodiment of the subject matter disclosed herein. Referring to FIG. 1, STP node 100 can include a high-speed communications bus 102, referred to herein as the interprocessor message transport (IMT) bus. A number of distributed processing modules or cards can be coupled to IMT bus 102, including a first SS7-capable link interface module (LIM) 104, a second SS7-capable LIM 106, a first database services module (DSM) 108, a second DSM 110, and a data communications module (DCM) 112. LIMs 104 and 106 may provide SS7 links and X.25 links. DSMs 108 and 110 can include one or more message processing applications 114 and 116, such as the ISUP screening application described in the '674 Publication referenced above or a triggerless location portability application. STP node 100 may be configured to load share processing of received signaling messages requiring processing among DSMs 108 and 116. DCM 110 can provide an Internet protocol (IP) signaling interface to external nodes. STP node 100 may also include a MASP pair 118 which provides maintenance communications, initial program load, peripheral services, alarm processing, and system disks.

Processing applications 114 and 116 illustrated in FIG. 1 may be implemented on cards or modules, such as DSMs 108 and 110, that are physically connected to IMT bus 102 such that signaling and other types of messages may be routed internally between the cards or modules. DSMs 108 and 110 may be identically provisioned, and LIMs 104 and 106 may load share messages requiring processing between DSMs 108 and 110. Such load sharing may lead to further mis-ordering of messages without the subject matter described herein. In an alternative embodiment of the subject matter disclosed herein, the processing applications may be implemented on external computing platforms, such as the TEKSERVER® platform (all available from Tekelec of Calabasas, Calif.), which may be directly coupled to IMT bus 102 via Ethernet interface modules (not shown in FIG. 1).

For simplicity of illustration, only two LIMs 104 and 106, two DSMs 108 and 110, and one DCM 112 are illustrated in FIG. 1. However, the distributed processing architecture of STP node 100 enables multiple LIM, DSM, DCM, the Tekelec TEKSERVER™ platform, and other processing modules to be simultaneously coupled to IMT bus 102. Furthermore, multiple application processor groups or subsystems may be included in STP node 100 without departing from the scope of the subject matter disclosed herein.

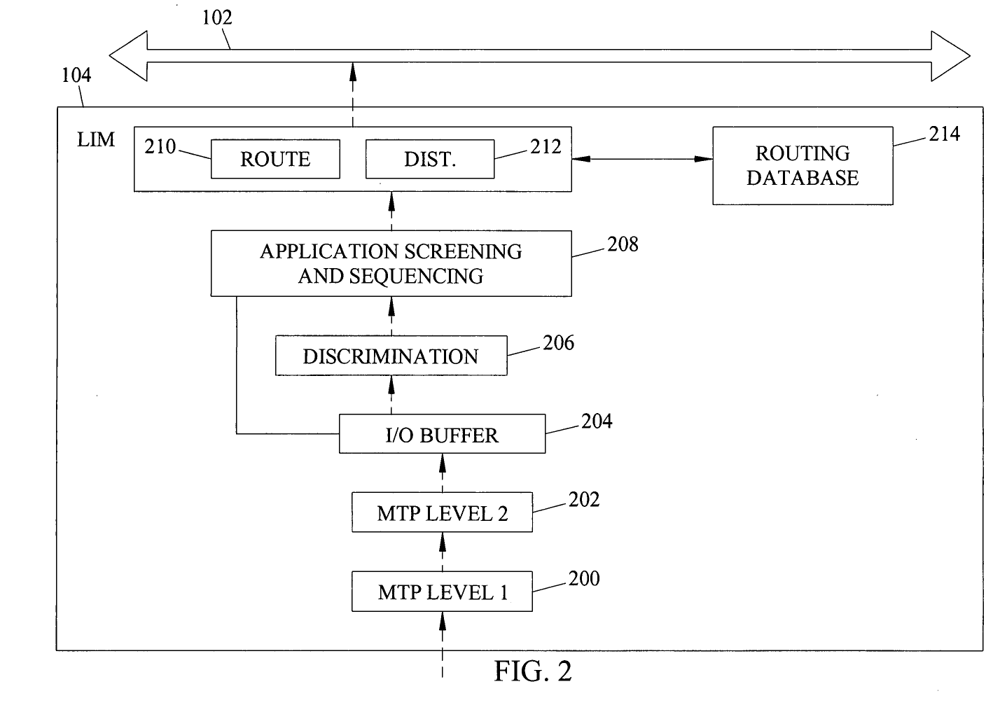

FIG. 2 illustrates an exemplary internal architecture for LIM 104 shown in FIG. 1. Referring to FIG. 2, LIM 104 includes a number of functions including an SS7 MTP level 1 function 200, an MTP level 2 function 202, an I/O buffer 204, an SS7 MTP level 3 message handling and discrimination (HMDC) function 206, an application screening and sequencing function 208, a message routing function 210, a message handling and distribution (HMDT) function 212, and a routing information database 214. MTP level 1 function 200 sends and receives digital data over a particular physical interface. MTP level 2 function 202 provides error detection, error correction, and sequenced delivery of SS7 message packets. I/O buffer 204 provides temporary buffering of incoming and outgoing signaling messages.

HMDC function 206 can receive an incoming signaling message from the lower processing layers and determine whether the message is addressed to and consequently requires processing by one or more processing applications in STP node 100. Application screening and sequencing function 208 can examine an incoming signaling message, which may not be addressed to STP node 100, and determine whether the message requires processing by processing application, such as processing applications 114 and 116 (shown in FIG. 1), in STP node 100. Application screening and sequencing function 208 also generates a sequence identifier for each message identified as requiring processing by one of applications 114 or 116. The sequence identifier is incremented for each new message identified by a particular LIM or DCM as requiring processing by one of application 114 or 116. As such, sequenced messages received over the same signaling link will be assigned sequence numbers that reflect the order in which the messages are received. After assignment of a sequence identifier, the signaling message can be forwarded to a processing application.

For messages such as IAM and SAM messages, the order in which the messages should be transmitted from STP 100 is the order in which the signaling messages are received. In other words, these signaling messages should be transmitted in a FIFO order. In one exemplary implementation, after processing by an application on a DSM, a message may be returned to an originating LIM and stored in buffer 204. Application screening and sequencing function 208 may control the sending of messages from I/O buffer 204 such that messages with sequence number 2 is returned to I/O buffer 204 before a message with sequence number 1, the message with sequence number 2 will be buffered until the message with sequence number 1 is returned to the LIM after processing by one of applications 114 and 116. Once the message with sequence number 1 is returned, the LIM may send the message with sequence number 1 followed by the message with sequence number 2 to the outbound signaling link.

In an alternate embodiment, rather than returning messages to the originating LIM and buffering the messages at the originating LIM before sending the messages to the LIM or DSM associated with the outbound signaling link, the messages may instead be forwarded directly to the LIM or DCM associated with the outbound signaling link after processing by a DSM application. In such an implementation, the LIM or DSM associated with the outbound signaling link may include an application screening and sequencing function that buffers and sends messages over the outbound signaling link according to the sequence numbers assigned by the receiving LIM or DCM.

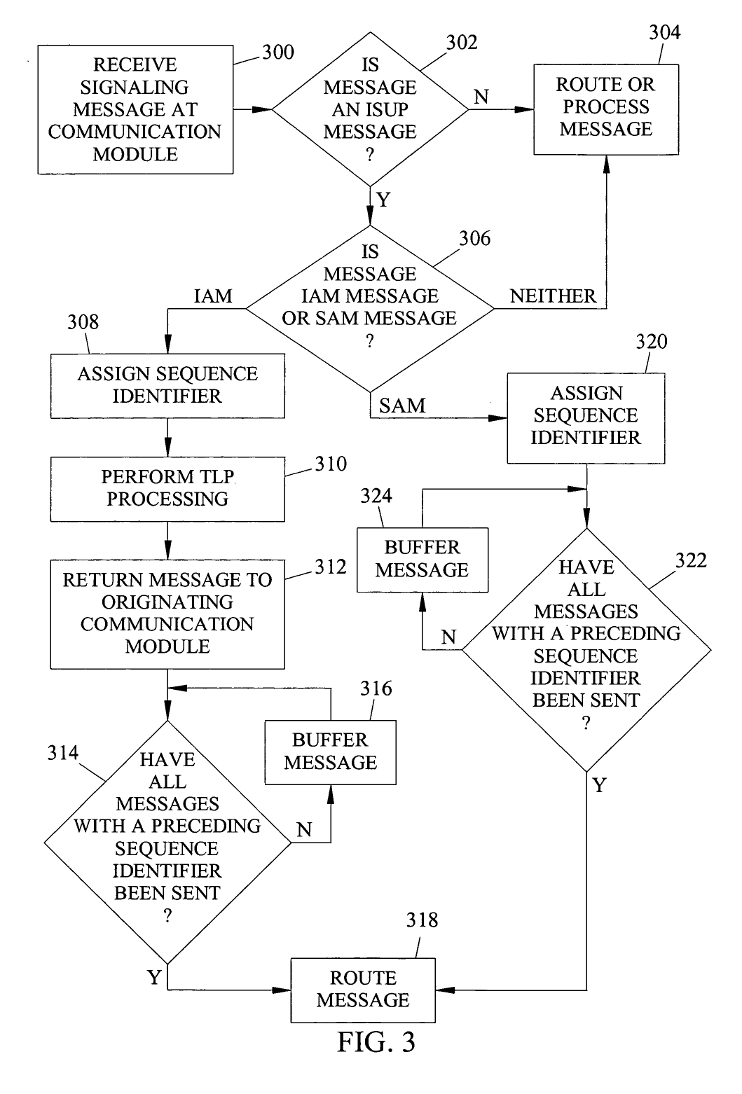

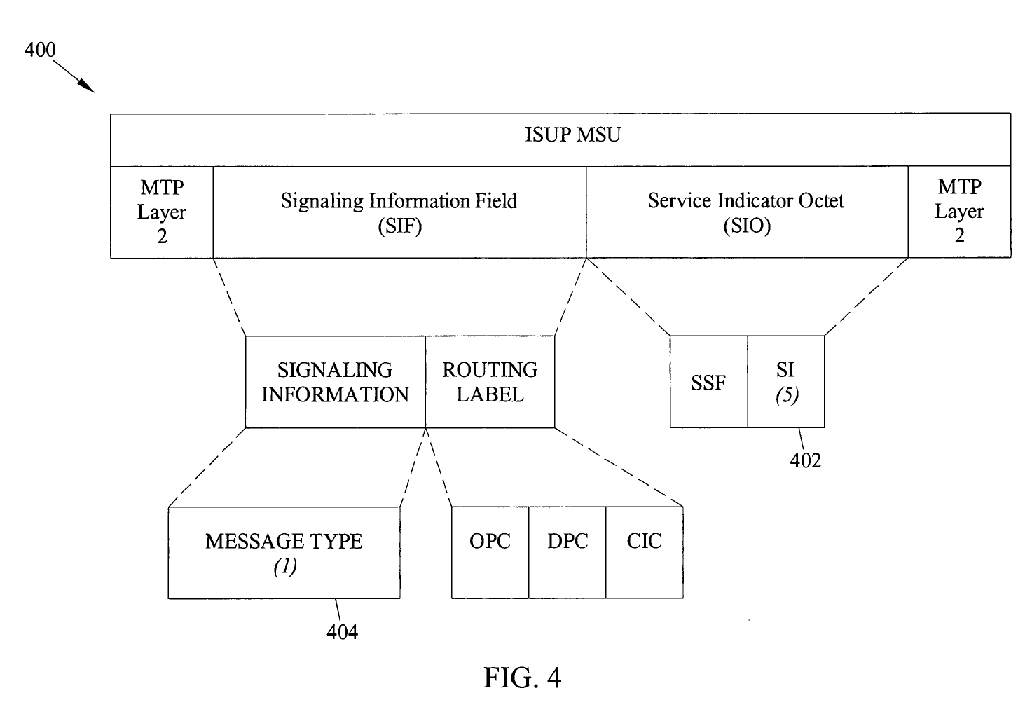

As stated above, maintaining proper sequencing of ISUP IAM and SAM messages in a distributed processing environment such as STP node 100 can be important so that these messages are not dropped at their destination. FIG. 3 is a flow chart illustrating exemplary steps that may be performed by application screening and sequencing function 208 and I/O buffer 204 in preserving sequencing of ISUP IAM messages and ISUP SAM messages according to an embodiment of the subject matter disclosed herein. Referring to step 300 of FIG. 3, a signaling message is received at LIM 104 and is passed up the stack to application screening and sequencing function 208. Application screening and sequencing function 208 examines parameters associated with the received signaling message and determines whether the received signaling message is an ISUP message (step 302). This determination may be made by examining a service indicator (SI) parameter contained in the service indicator octet (SIO) field of the MTP routing label of the signaling message. Referring to FIG. 4, an ISUP message 400 includes an SI parameter 402 with a value of 5 identifying the ISUP message type. The SI value of 5 indicates that message 400 is an ISUP message. If the signaling message is not an ISUP message (i.e., the SI value is not 5), no further screening and sequencing processing need be performed by function 208, and the message may be passed along for additional screening operations, processing, or simply routed to its destination (step 304). The message may be forwarded to an appropriate outbound LIM based on MTP routing information, such as the values contained in DPC field 406 and CIC field 408.

If it is determined the received signaling message is an ISUP message (i.e., the SI value is 5), function 208 can examine a message type parameter contained in the message to determine whether the message is an IAM message or a SAM message (step 306). A message type parameter of 1 indicates that the message is an IAM message, and a message type parameter of 2 indicates that the message is a SAM message. Referring to FIG. 4, message type parameter 404 can be found in the signaling information portion of the MSU. A value of 1 indicates that message 400 is an IAM message. If the signaling message is neither an IAM message nor a SAM message, no further screening and sequencing processing need be performed by function 208, and the message may be passed along for additional screening operations, processing, or routed towards its destination (step 304). If the message is an IAM message or a SAM message, sequencing is required for the messages because IAM and SAM messages are preferably transmitted from a routing node, such as an STP, in the same order in which they were received by the routing node.

In order to guarantee such sequencing, if a received message is determined to be an IAM message at step 306, a sequence identifier can be assigned to and associated with the signaling message (step 308). The sequence identifier for the IAM message can be a number or other alphanumeric character that is one greater than or one less than a number or character of the sequence identifier assigned to the IAM or SAM message received by a LIM or DCM immediately before the currently received IAM message. As a result, a sequence identifier is assigned to the IAM message such that the receipt order of the IAM message with respect to other IAM and SAM messages received by the same LIM or DCM can be known by the sequence identifiers of the IAM and SAM messages.

After a sequence identifier has been assigned and associated with the IAM message, the IAM message can be forwarded to one of a plurality of the application processors in STP node 100 for further processing (step 310). For example, further processing of the IAM message may include, but is not limited to, triggerless pre-paid services processing or location portability processing by a triggerless location portability (TLP) processing application, such as one of processing applications 114 and 116. After location portability processing of the IAM message, the IAM message can be returned to LIM 104 or forwarded to another module, such as LIM 106, for outbound communication (step 312).

LIM 104 can receive the IAM message and check the sequence identifier associated with the IAM message to determine whether all messages with preceding sequence identifiers have been transmitted to their destination (step 314). If all messages with preceding sequence identifiers have not been transmitted, the IAM message can be buffered at LIM 104 until all messages with preceding sequence identifiers have been transmitted (step 316). One reason that messages received by an originating LIM may be misordered is that IAM messages may require internal processing within STP while SAM messages may not. Thus, without the subject matter described herein, a SAM message may be received and routed while the corresponding IAM message is being processed. To avoid sending such messages to their destination out of sequence, after all of the IAM messages with preceding sequence identifiers have been transmitted, the IAM message can be routed to its destination (step 318). Routing the message to its destination may include performing a lookup in a route table on the originating LIM, identifying an outbound LIM associated with the outbound signaling link, and forwarding the message to the outbound LIM or DCM.

As stated above, instead of buffering the IAM message at LIM 104, the IAM message can be buffered at any suitable component of STP node 100 to await outbound transmission. For example, the IAM message can be buffered by outbound LIM 106, outbound DCM 110 or any suitable LIM, DSM, or DCM of STP node 100.

Referring again to step 306, if a received message is determined to be an SAM message, a sequence identifier can be assigned to and associated with the SAM message (step 320). Similar to the assignment of sequence identifiers to IAM messages, the sequence identifier for the SAM message can be a number or other alphanumeric character that is one greater than or one less than a number or character of the sequence identifier assigned to the IAM or SAM message received immediately before the currently received SAM message. As a result, a sequence identifier is assigned to the SAM message such that the receipt order of the SAM message with respect to other IAM and SAM messages can be known by the sequence identifiers of the IAM and SAM messages. Because the SAM message does not require location portability processing, the SAM message does not require transmission to one of the processing applications as required for the IAM message. Further, sequencing of the SAM message with respect to an associated IAM message is preserved by the assignment of sequence identifiers to the messages and making sure that the messages are transmitted from STP 100 in order based on the sequence numbers.

After a sequence identifier has been assigned and associated with the SAM message, LIM 104 can check the sequence identifier associated with the SAM message to determine whether all messages with preceding sequence identifiers have been transmitted to their destination (step 322). If all messages with preceding sequence identifiers have not been transmitted, the SAM message can be buffered at LIM 104 until all messages with preceding sequence identifiers have been transmitted (step 324). After all of the messages with preceding sequence identifiers have been transmitted, the SAM message can be routed to its destination (step 318). Routing the message to its destination may include performing a lookup in a route table on the originating LIM, identifying an outbound LIM associated with the outbound signaling link, and forwarding the message to the outbound LIM or DCM.

As stated above, instead of buffering the SAM message at LIM 104, the SAM message can be buffered at any suitable component of STP node 100 for awaiting outbound transmission. For example, the SAM message can be buffered by outbound LIM 106, outbound DCM 110 or any suitable LIM, DSM, or DCM of STP node 100.

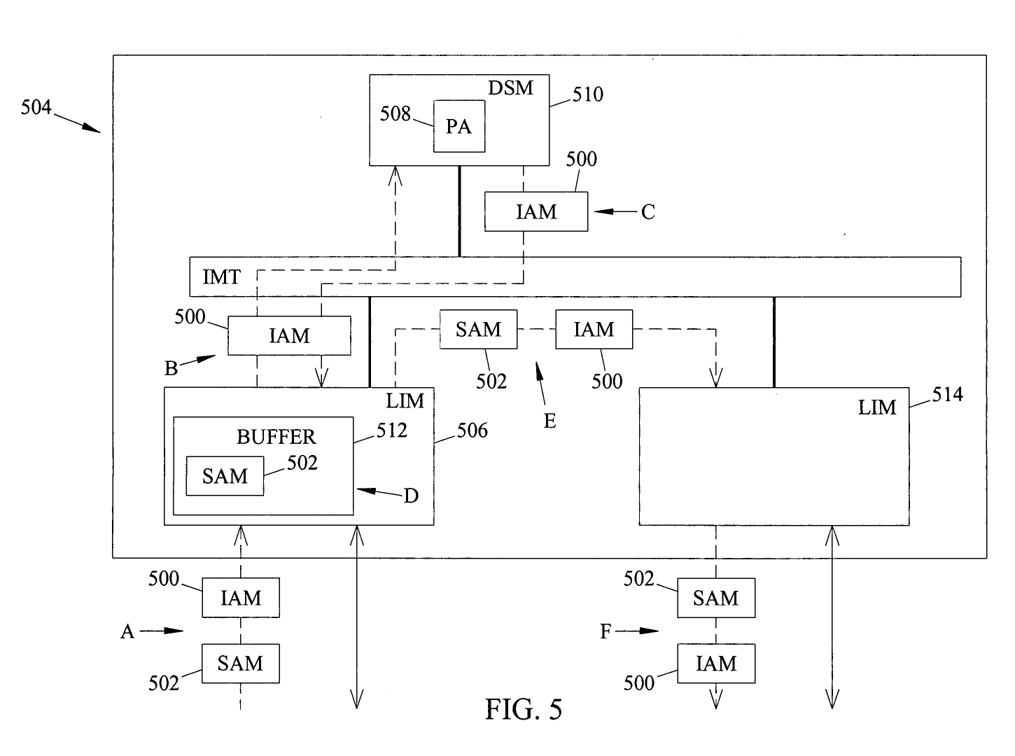

FIG. 5 illustrates an example of the communication of an IAM message 500 and a SAM message 502 through the internal architecture of an exemplary STP node 504 according to one embodiment of the subject matter disclosed herein. STP 504 may include components, such as LIMs, DCMs, and DSMs with message sequencing and buffering functionality similar to STP 100 illustrated in FIG. 1. In this illustration, IAM message 500 and SAM message 502 are associated with one another and should be transmitted from STP node 504 in a FIFO order. Referring generally to reference A of FIG. 5, IAM message 500 is received at LIM 506 and subsequently followed by SAM message 502. Next, IAM message 500 can be associated with a sequence identifier, such as the number 1. SAM message 502 can also be associated with a sequence identifier, such as the number 2, to indicate that SAM message 502 was received after IAM message 500.

Referring generally to reference B of FIG. 5, LIM 506 can determine that IAM message 500 requires additional processing, such as location portability processing, and forward IAM message 500 to a processing application 508 in DSM 510 for further processing. After processing by processing application 508, IAM message 500 is returned to LIM 506 for outbound communication (reference C) At reference D, SAM message 502 may be stored at a buffer 512 of LIM 506 until IAM message 500 is processed by application 508, returned to LIM 506, and routed from LIM 506 for outbound communication. LIM 506 can determine that SAM message 502 should be maintained in buffer 512 because SAM message 502 is associated with a sequence identifier (i.e., value 2) that is after the sequence identifier (i.e., value 1) associated with IAM message 504. IAM message 504 may also be buffered at buffer 512 until all preceding messages have been transmitted. Accordingly, when all preceding messages have been transmitted, IAM message 500 followed by SAM message 502 can be transmitted to LIM 514 for outbound communication (reference E). As a result, IAM message 500 and SAM message 502 are transmitted from STP node 504 in the sequence that the messages were received. Thus, although IAM message 500 required further processing, SAM message 502 was buffered until it could be sent in an FIFO order with IAM message 500.

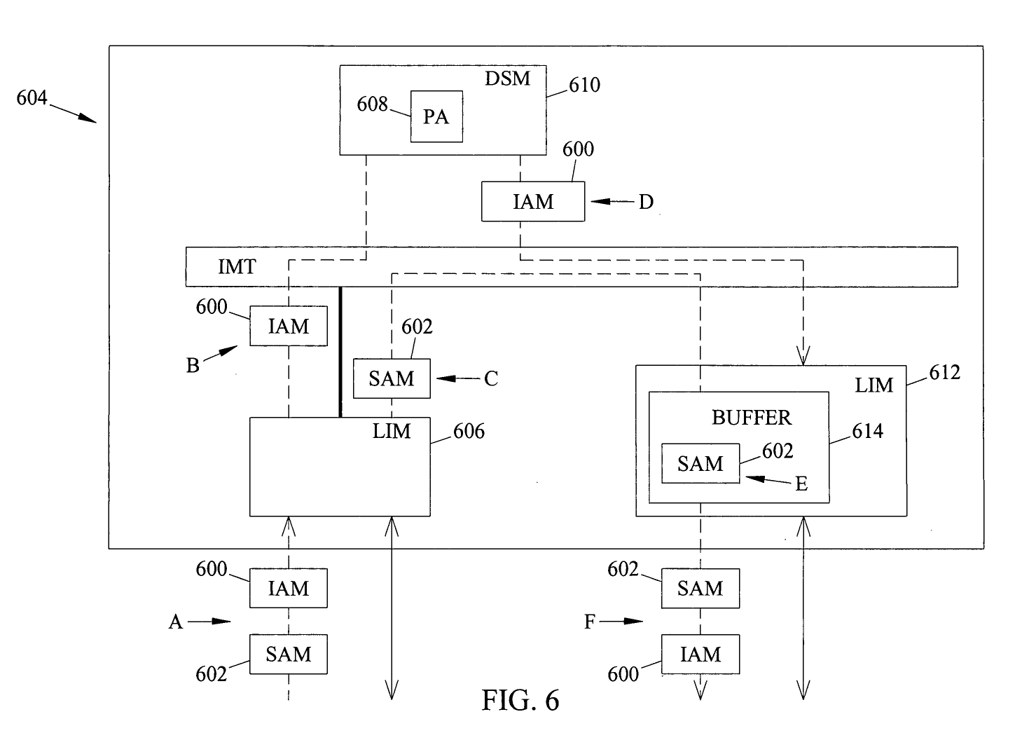

FIG. 6 illustrates another example of the communication of an IAM message 600 and a SAM message 602 through the internal architecture of an exemplary STP node 604 according to one embodiment of the subject matter disclosed herein. STP 604 may include LIMs, DCMs, and DSMs with messaging sequencing and buffering functionality similar to that illustrated in FIG. 1. In this illustration, IAM message 600 and SAM message 602 are associated and should be communicated from STP node 604 in a FIFO order. Referring generally to reference A of FIG. 6, IAM message 600 is received at LIM 606 and subsequently followed by SAM message 602. Next, IAM message 600 can receive a sequence identifier-such as the number 1. SAM message 602 can also receive a sequence identifier, such as the number 2, to indicate that SAM message 502 was received subsequent to IAM message 600.

Referring generally to reference B of FIG. 6, LIM 606 can determine that IAM message 600 requires additional processing, such as location portability processing, and forward IAM message 600 to a processing application 608 in a DSM 610 for further processing. LIM 606 can also route SAM message 602 to a LIM 612 for outbound communication (reference C). After processing by processing application 608, IAM message 600 is routed to LIM 612 for outbound communication (reference D).

At reference E, SAM message 602 may be stored at a buffer 614 of LIM 612 until IAM message 600 is received at LIM 612 for outbound communication. LIM 612 can determine that SAM message 602 should be maintained in buffer 614 because SAM message 602 is associated with a sequence identifier (i.e., value 2) that is after the sequence identifier (i.e., value 1) associated with IAM message 604. IAM message 604 may also be buffered at buffer 614 until all preceding messages have been transmitted. Accordingly, when all preceding messages have been transmitted, IAM message 600 followed by SAM message 602 can be transmitted from STP 604 (reference F). As a result, IAM message 600 and SAM message 602 are transmitted from STP 604 in the sequence that the messages were received. Thus, although IAM message 600 required further processing, SAM message 602 was buffered until it could be sent in an FIFO order with IAM message 600.

According to one embodiment, buffer 614 may also maintain IAM and SAM messages received at a plurality of inbound modules of STP node 604. Thus, messages forwarded to LIM 612 for outbound communication may be from one a plurality of inbound modules. In order to assure that sequencing numbers for buffering the messages at buffer 614 are confused with one another, a second sequencing number may be assigned to the message based on the inbound module associated with the message. As described herein, message may be communicated from LIM 612 in a FIFO based on the first sequencing number assigned to the message at the inbound module. In addition, the messages may be communicated from LIM 612 in a round robin fashion based on the second sequencing number assigned to the message. Thus, the sequencing numbers assigned at the inbound modules are not confused with one another because messages are associated with an additional sequencing number corresponding to its corresponding inbound module.

Accordingly, one advantage of the subject matter disclosed herein is that messages are transmitted from an STP node in a FIFO order, even when some messages require internal processing and others do not. This feature is important for messages that are related and require communication to their destination in the order that the messages were received at the routing node. Although the above examples relate to ISUP IAM and SAM messages, the subject matter described herein can be applied to any signaling message, such as any type of MTP, SIGTRAN, or IP telephony message, requiring FIFO sequencing at a network node.

As described above, preserving proper sequencing of ISUP IAM and SAM message can be important in order to avoid message dropping. The subject matter disclosed herein can provide proper sequencing of ISUP IAM and SAM messages through an STP node. Further, SAM messages are not required to follow associated IAM messages through processing in STP node in order to maintain proper sequencing. As a result, internal bandwidth consumption in the STP node is reduced. Further, IAM messages may be load-shared among multiple location portability processing applications while maintaining proper outbound sequencing. Moreover, correlation of signaling messages is not required to preserve sequencing.

It will be understood that various details of the invention may be changed without departing from the scope of the invention. Furthermore, the foregoing description is for the purpose of illustration only, and not for the purpose of limitation, as the invention is defined by the claims as set forth hereinafter.

What is claimed is:

1. A method for preserving sequencing of signaling messages, the method comprising:
(a) receiving first and second signaling messages at a routing node of a communications network, wherein the first signaling message is received prior to the second signaling message;
(b) determining whether processing is required for the first signaling message;
(c) in response to determining that processing is required for the first signaling message, assigning first and second sequence identifiers to the first and second signaling messages, respectively, the first and second sequence identifiers identifying a relative sequence for routing the first and second signaling messages from the routing node; and
(d) routing the first and second signaling messages to the communications network according to the relative routing sequence identified by the first and second sequence identifiers.

2. The method of claim 1 wherein the first and second signaling messages comprise SS7 MTP-routed messages.

3. The method of claim 1 wherein the first and second signaling messages comprise ISDN user part (ISUP) messages.

4. The method of claim 3 wherein the first and second signaling messages comprise an ISUP initial address message (IAM) and an ISUP subsequent address message (SAM), respectively.

5. The method of claim 1 wherein the routing node comprises signal transfer point (STP).

6. The method of claim 1 wherein determining whether processing is required for the first signaling message includes determining whether triggerless location portability processing is required for the first signaling message.

7. The method of claim 1 wherein determining whether processing is required for the first signaling message includes determining whether triggerless pre-paid services processing is required for the first signaling message.

8. The method of claim 1 wherein determining whether processing is required for the first signaling message includes determining whether the first signaling message is an ISUP IAM message.

9. The method of claim 1 wherein the first and second sequence identifiers are first and second numbers, respectively, wherein the second number is one greater than or one less than the first number.

10. The method of claim 1 wherein routing the first and second messages includes buffering the second signaling message until the first signaling message has been communicated.

11. The method of claim 10 wherein buffering the second signaling message includes determining whether messages associated with preceding sequence identifiers have been communicated.

12. The method of claim 11 wherein routing the first and second messages includes, in response to determining that messages associated with preceding identifiers have been routed, routing the second signaling message to the communications network.

13. The method of claim 1 comprising processing the first signaling message.

14. The method of claim 13 comprising buffering the second signaling message during the processing of the first signaling message.

15. The method of claim 14 comprising routing the second message after the processing and routing of the first signaling message.

16. The method of claim 14 wherein buffering the second signaling message includes buffering at an inbound communication module.

17. The method of claim 14 wherein buffering the second signaling message includes buffering at an outbound communication module.

18. A system for preserving sequencing of signaling messages, the system comprising:
(a) at least one communications module for receiving first and second signaling messages from a signaling network; and
(b) an application screening and sequencing function for determining whether processing is required for the first signaling message, and, in response to determining that processing is required, for assigning first and second sequence identifiers to the first and second signaling messages, respectively, wherein the first and second sequence identifiers identify relative sequence for routing the first and second signaling messages, wherein the at least one communications module is operable to route the first and second signaling messages according to the relative sequence identified by the first and second sequence identifiers.

19. The system of claim 18 wherein the first and second signaling messages comprise SS7 MTP-routed messages.

20. The system of claim 18 wherein the first and second signaling messages comprise ISUP messages.

21. The system of claim 20 wherein the first and second signaling messages comprise an ISUP initial address message (IAM) and an ISUP subsequent address message (SAM) message, respectively.

22. The system of claim 18 wherein the application screening and sequencing function is operable to determine whether triggerless location portability processing is required for the first signaling message.

23. The system of claim 19 wherein the application screening and sequencing function is operable to determine whether triggerless pre-paid services processing is required for the first signaling message.

24. The system of claim 18 wherein the application screening and sequencing function is operable to determine the first signaling message is an ISUP IAM message.

25. The system of claim 18 wherein the first and second sequence identifiers are first and second numbers, respectively, wherein the second number is one greater than or one less than the first number.

26. The system of claim 18 comprising a buffer for buffering the second signaling message until the first signaling message has been communicated.

27. The system of claim 26 wherein the application screening and sequencing function is operable to determine whether messages associated with preceding sequence identifiers have been communicated.

28. The system of claim 27 the at least one communications module is operable to route the second signaling message to the communications network in response to determining that messages associated with preceding identifiers have been routed.

29. The system of claim 18 comprising a processing application operable to process the first signaling message.

30. The system of claim 29 comprising a buffer operable to buffer the second signaling message during the sequenced processing of the first signaling message.

31. The system of claim 30 wherein the buffer is on an outbound communication module.

32. The system of claim 30 wherein the buffer is on a receiving communication module.

33. The system of claim 30 wherein the at least one communications module is operable to route the second message after the processing and routing of the first signaling message.

34. A computer program product comprising computer executable instructions embodied in a computer readable medium for performing the steps comprising:
(a) receiving first and second signaling messages at a routing node of a communications network, wherein the first signaling message is received prior to the second signaling message;
(b) determining whether processing is required for the first signaling message;
(c) in response to determining that processing is required for the first signaling message, assigning first and second sequence identifiers to the first and second signaling messages, respectively, the first and second sequence identifiers identifying a relative sequence for routing the first and second signaling messages from the routing node; and
(d) routing the first and second signaling messages to the communications network according to the relative routing sequence identified by the first and second sequence identifiers.

35. The computer program product of claim 34 wherein the first and second signaling messages comprise SS7 MTP-routed messages.

36. The computer program product of claim 34 wherein the first and second signaling messages comprise ISDN user part (ISUP) messages.

37. The computer program product of claim 36 wherein the first and second signaling messages comprise an ISUP initial address message (IAM) and an ISUP subsequent address message (SAM), respectively.

38. The computer program product of claim 34 wherein the routing node comprises signal transfer point (STP).

39. The computer program product of claim 34 wherein determining whether processing is required for the first signaling message includes determining whether triggerless location portability processing is required for the first signaling message.

40. The computer program product of claim 34 wherein determining whether processing is required for the first signaling message includes determining whether triggerless pre-paid services processing is required for the first signaling message.

41. The computer program product of claim 34 wherein determining whether processing is required for the first signaling message includes determining whether the first signaling message is an ISUP IAM message.

42. The computer program product of claim 34 wherein the first and second sequence identifiers are first and second numbers, respectively, wherein the second number is one greater than or one less than the first number.

43. The computer program product of claim 34 wherein routing the first and second messages includes buffering the second signaling message until the first signaling message has been communicated.

44. The computer program product of claim 43 wherein buffering the second signaling message includes determining whether messages associated with preceding sequence identifiers have been communicated.

45. The computer program product of claim 44 wherein routing the first and second messages includes, in response to determining that messages associated with preceding identifiers have been routed, routing the second signaling message to the communications network.

46. The computer program product of claim 34 comprising processing the first signaling message.

47. The computer program product of claim 46 comprising buffering the second signaling message during the processing of the first signaling message.

48. The computer program product of claim 47 comprising routing the second message after the processing and routing of the first signaling message.

49. The computer program product of claim 47 wherein buffering the second signaling message includes buffering at an inbound communication module.

50. The computer program product of claim 47 wherein buffering the second signaling message includes buffering at an outbound communication module.
